(19) United States
(12) Patent Application Publication
(10) Pub. No.: US 2009/0231522 A1
(43) Pub. Date: Sep. 17, 2009

(54) LIQUID CRYSTAL DISPLAY PANEL AND METHOD FOR MANUFACTURING THE SAME

(76) Inventors: Hee-Joon KIM, Cheonan-si (KR); Jun-Ho Song, Seongnam-si (KR); Joo-Han Kim, Yongin-si (KR)

Correspondence Address: Haynes and Boone, LLP;IP Section, 2323 Victory Avenue, SUITE 700, Dallas, TX, 75219, US

(21) Appl. No.: 12/191,966

(22) Filed: Aug. 14, 2008

(30) Foreign Application Priority Data
Mar. 12, 2008 (KR) 10-2008-0022790

(51) Int. Cl. G02F 1/1339; G02F 1/1335; G02F 1/1341

(52) U.S. Cl. 349/106; 349/155; 349/189

(57) ABSTRACT

Embodiments of a liquid crystal display panel include a first substrate, a second substrate and a liquid crystal layer interposed between the first substrate and the second substrate. The first substrate may include a color filter layer covering a thin-film transistor and having a recess portion. The second substrate may include a first spacer making contact with the first substrate and a second spacer disposed at a position corresponding to the recess portion of the color filter layer to be separated from the first substrate. The first substrate may further include a protrusion pattern formed under the recess portion of the color filter layer. The second spacer may be correspondingly disposed at a position where the recess portion and the protrusion pattern are formed.

### PRIORITY STATEMENT

This application claims priority to and benefit from Korean Patent Application No. 2008-022790, filed on Mar. 12, 2008 in the Korean Intellectual Property Office (KIPO), the contents of which are herein incorporated by reference in their entirety.

### BACKGROUND

1. Technical Field

Example embodiments of the present invention generally relate to a liquid crystal display panel and a method for manufacturing the liquid crystal display panel. More particularly, example embodiments of the present invention relate to a liquid crystal display panel for dispersion of an external stress and a uniform distribution of liquid crystal molecules, and a method for manufacturing the liquid crystal display panel.

2. Description of the Related Art

Generally, a liquid crystal display device has many advantages such as thinness, low electric power consumption, etc. Therefore, the liquid crystal display device may be used in a monitor, a laptop computer, a cellular phone, a large size television, etc. The liquid crystal display device includes a liquid crystal display panel for displaying an image by using the light transmittance of liquid crystal molecules and a backlight assembly disposed under the liquid crystal display panel to provide the liquid crystal display panel with light.

The liquid crystal display panel includes a lower substrate and an upper substrate. A switching element and a pixel electrode are formed on the lower substrate, and a common electrode is formed on the upper substrate. The liquid crystal display panel includes a color filter layer for displaying a color image. The color filter layer may be formed on the lower substrate where the switching element is formed, or it may be formed on the upper substrate where the common electrode is formed. The latter structure is called a color filter on array (COA) structure. As compared to the former structure, the COA structure is advantageously capable of reducing errors in a coupling alignment. The errors may include a mismatch between color filters and a corresponding pixel region when the two substrates are combined with each other.

A liquid crystal display panel manufactured by a method of dropping liquid crystal molecules includes a plurality of spacers regularly arranged to maintain a uniform cell gap between the two substrates. When the number of spacers is too small, a stress applied to each spacer is so large that the spacer may be easily transformed or broken down. Conversely, when the number of spacers is too large, the liquid crystal molecules may not be regularly distributed. In order to solve the above-mentioned problems, a liquid crystal display panel employing a dual spacer has been developed. The liquid crystal display panel employing the dual spacer includes two kinds of spacers having respective combined heights different from each other, which are originated from a step difference between an area where a thin-film transistor is formed and an area where a thin-film transistor is not formed.

However, in the liquid crystal display panel having a COA structure, a flat color filter layer covers the thin-film transistor, and thus the step difference is not generated. Therefore, the liquid crystal display panel having the COA structure may not employ the dual spacer utilizing the step difference that is generated in the region where the thin-film transistor is formed.

### SUMMARY

Example embodiments of the present invention provide a liquid crystal display panel capable of employing a dual spacer as well as having a color filter on array (COA) structure.

Example embodiments of the present invention provide a method for manufacturing the liquid crystal display panel.

In accordance with an aspect according to an embodiment of the present invention, there is provided a liquid crystal display panel including a first substrate, a second substrate and a liquid crystal layer interposed between the first substrate and the second substrate. The first substrate includes a first base substrate, a thin-film transistor formed on the first base substrate and a color filter layer covering the thin-film transistor and having a recess portion. The second substrate includes a second base substrate, a first spacer formed on the second base substrate and a second spacer formed on the second base substrate. The first spacer makes contact with the first substrate. The second spacer is disposed at a position corresponding to the recess portion of the color filter layer to be separated from the first substrate.

In some example embodiments of the present invention, the first spacer may be disposed at a position corresponding to where the thin-film transistor is formed. The first spacer and the second spacer may have substantially the same length.

In some example embodiments of the present invention, the first substrate may further include a protrusion pattern formed under the recess portion of the color filter layer, and the second spacer may be disposed at a position corresponding to a portion where the recess portion and the protrusion pattern are formed. The first substrate may further include a gate line extending in a first direction, and the protrusion pattern may protrude from the gate line. A perimetric size of the protrusion pattern may be substantially the same as or larger than that of the recess portion.

In some example embodiments of the present invention, the first substrate may be divided into a plurality of pixel regions. The pixel regions may include a red pixel region where a red color filter layer is formed, a green pixel region where a green color filter layer is formed, and a blue pixel region where a blue color filter layer is formed. The protrusion pattern may be formed only in the blue pixel region, and the second spacer may be formed only in the blue pixel region. Alternatively, the protrusion pattern may be formed in every pixel region, and the second spacer may be formed only in the blue pixel region.

In an example embodiment of the present invention, the first substrate may further include a pixel electrode electrically connected to the thin-film transistor through a contact hole perforated through the color filter layer. The recess portion may correspond to the contact hole, and the second spacer may be disposed over the contact hole.

In accordance with another aspect according to another embodiment of the present invention, there is provided a liquid crystal display panel including a first substrate, a second substrate and a liquid crystal layer interposed between the first substrate and the second substrate. The first substrate includes a first base substrate, a thin-film transistor formed on the first base substrate and a color filter layer covering the thin-film transistor and having a recess portion. The second substrate includes a second base substrate, a shading layer formed at a portion of the second base substrate, a first spacer formed on a region where the shading layer is formed and a second spacer formed on a region where the shading layer is not formed. The first spacer makes contact with the first substrate. The second spacer is separated from the first substrate.

In an example embodiment of the present invention, the shading layer may be formed at a position corresponding to where the thin-film transistor is formed.

In an example embodiment of the present invention, the shading layer may have a perforated hole exposing a portion of the second base substrate, and the second spacer may be disposed in the perforated hole.

In accordance with an aspect of an embodiment of the present invention, there is provided a method of manufacturing a liquid crystal display panel. According to the method, a first substrate including a color filter layer is formed. The color filter layer covers a thin-film transistor formed on a first base substrate, and has a recess portion. A second substrate including a first spacer and a second spacer is formed. The first spacer is formed on a second base substrate to make contact with the first substrate. The second spacer is disposed at a position corresponding to the recess portion of the color filter layer. Liquid crystal molecules are dropped on the first substrate. The first substrate and the second substrate are combined so that the first spacer makes contact with the first substrate and the second substrate is disposed over the recess portion.

In some example embodiments of the present invention, the first substrate may be formed by the following process. A gate pattern is formed on the first base substrate. The gate pattern includes a gate line and a gate electrode extending from the gate line. A data line, a source electrode and a drain electrode are formed. A photoresist is formed. The photoresist covers the gate electrode, the source electrode and the drain electrode. The photoresist is patterned to form a color filter layer having a recess portion.

In an example embodiment of the present invention, the gate pattern may further include a protrusion pattern protruding from the gate line, and the protrusion pattern may be formed at a region corresponding to where the recess portion is formed.

In an example embodiment of the present invention, the photoresist may be patterned by the following process. A mask is disposed over the photoresist. The mask may have a slit disposed at a position where the recess portion is to be formed. The photoresist is exposed to external light, and developed to form the color filter layer.

In accordance with another aspect of the present invention, there is provided a method of manufacturing a liquid crystal display panel. According to the method, a first substrate including a color filter layer is formed. The color filter layer covers a thin-film transistor formed on a first base substrate. A second substrate including a shading layer, a first spacer and a second spacer is formed. The shading layer is formed on a portion of a second base substrate. The first spacer is formed on the shading layer to make contact with the first substrate. The second spacer is disposed at a region where the shading layer is not formed. Liquid crystal molecules are dropped on the first substrate. The first substrate and the second substrate are combined so that the first spacer makes contact with the first substrate and the second substrate is disposed over the recess portion.

In an example embodiment of the present invention, the second substrate may be formed by patterning the shading layer to have a perforated hole exposing a portion of the second base substrate and forming the second spacer in the perforated hole.

According to some example embodiments of the present invention, although a liquid crystal display panel has a COA structure, a second spacer may be separated from a substrate by a predetermined distance. Therefore, the liquid crystal display panel having the COA structure may employ the dual spacer.

Accordingly, a stress applied from an exterior may be uniformly dispersed, and liquid crystal molecules may be regularly distributed.

### BRIEF DESCRIPTION OF THE DRAWINGS

The above and other features and advantages of embodiments of the present invention will become more apparent by describing in detail example embodiments thereof with reference to the accompanying drawings.

FIG. 1 is a plan view illustrating a liquid crystal display panel in accordance with an example embodiment of the present invention;

FIG. 2 is an enlarged partial plan view of the portion “A” corresponding to a portion of a first substrate illustrated in FIG. 1;

FIG. 3 is a cross-sectional view of the liquid crystal display panel taken along lines I-I′ in FIG. 1;

FIG. 4 is a cross-sectional view illustrating a method of manufacturing a liquid crystal display panel illustrated in FIGS. 1 to 3 according to an embodiment;

FIG. 5 is a plan view illustrating a liquid crystal display panel in accordance with another example embodiment of the present invention;

FIG. 6 is a plan view illustrating a liquid crystal display panel in accordance with another example embodiment of the present invention;

FIG. 7 is a cross-sectional view of the liquid crystal display panel taken along lines II-II′ in FIG. 6;

FIG. 8 is a cross-sectional view of a liquid crystal display panel in accordance with another example embodiment of the present invention; and

FIG. 9 is a cross-sectional view of a liquid crystal display panel in accordance with still another example embodiment of the present invention.

### DETAILED DESCRIPTION

Embodiments of the present invention are described more fully hereinafter with reference to the accompanying drawings, in which example embodiments of the present invention are shown. The present invention may, however, be embodied in many different forms and should not be construed as limited to the example embodiments set forth herein. Rather, these example embodiments are provided so that this disclosure will be thorough and complete, and will fully convey the scope of the present invention to those skilled in the art. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numerals refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present disclosure.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular example embodiments only and is not intended to be limiting of the present disclosure. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments of the invention are described herein with reference to cross-sectional illustrations that are schematic illustrations of idealized example embodiments (and intermediate structures) of the present invention. As such, variations from the shapes of the illustrations as a result, for example, of manufacturing techniques and/or tolerances, are to be expected. Thus, example embodiments of the present invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present disclosure.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present invention will be explained in detail with reference to the accompanying drawings.

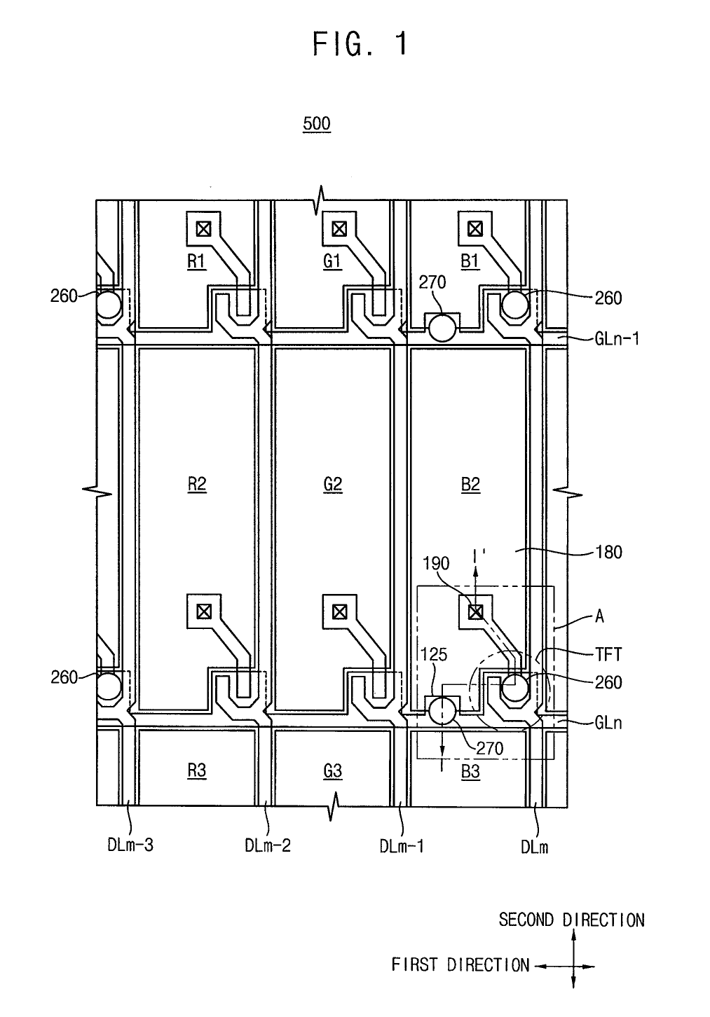

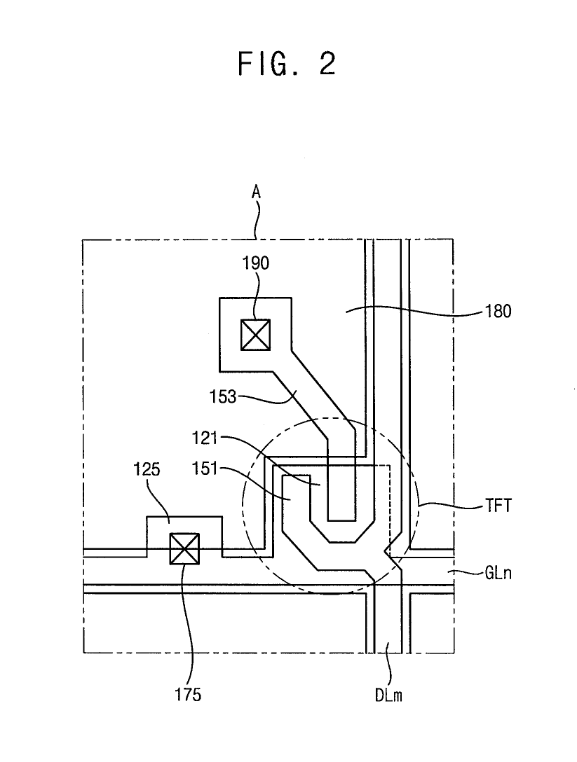

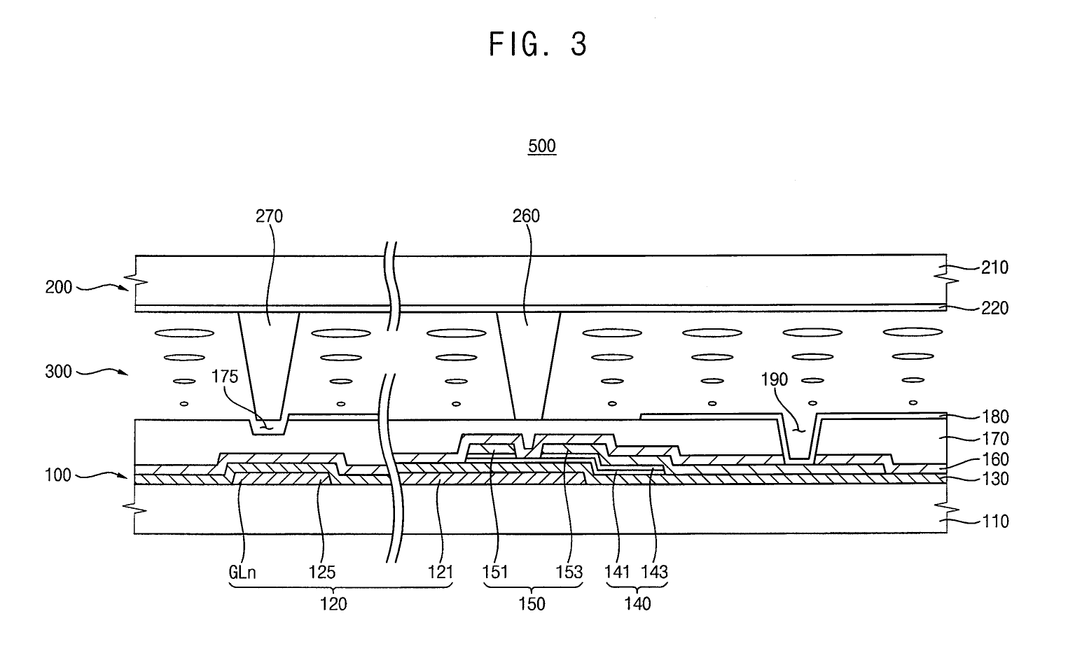

FIG. 1 is a plan view illustrating a liquid crystal display panel in accordance with an example embodiment of the present invention. FIG. 2 is an enlarged partial plan view of the portion “A” corresponding to a portion of a first substrate illustrated in FIG. 1, and FIG. 3 is a cross-sectional view of the liquid crystal display panel taken along lines I-I′ in FIG. 1.

Referring to FIGS. 1, 2 and 3, a liquid crystal display panel 500 includes a first substrate 100, a second substrate 200 and a liquid crystal layer 300 interposed between the first and second substrates 100 and 200.

A gate pattern 120 is formed on a first base substrate 110 of the first substrate 100. The gate pattern 120 includes a plurality of gate lines GLn-1 and GLn extending in a first direction, and a gate electrode 121 extending from the gate lines GLn-1 and GLn. Herein, ‘n’ represents a natural number larger than one. The gate electrode 121 is a control electrode through which a control signal controlling a switching element is applied to the switching element.

A data pattern 150 is formed on the first base substrate 110. The data pattern 150 includes a plurality of data lines DLm-3, DLm-2, DLm-1 and DLm extending in a second direction that is substantially perpendicular to the first direction, a source electrode 151 extending from the data lines DLm-3, DLm-2, DLm-1 and DLm, and a drain electrode 153 separated from the source electrode 151. Herein, ‘m’ represents a natural number larger than three. The source electrode 151 is an input electrode through which a data signal is applied to a switching element, and the drain electrode 153 is an output electrode through which a signal corresponding to the data signal is outputted. The gate electrode 121, the source electrode 151 and the drain electrode 153 constitute a thin-film transistor (TFT) that is a kind of switching element.

The first substrate 100 is divided into a plurality of pixel regions. In an example embodiment illustrated in FIG. 1, the TFT may be formed in each pixel region of the first substrate 100. A storage line (not illustrated) and a storage capacitor (not illustrated) may be further formed in the pixel region.

The first substrate 100 further includes a gate insulation layer 130 formed on the first base substrate 110 to cover the gate pattern 120. For example, the gate insulation layer 130 may comprise silicon nitride (SiNx) or silicon oxide (SiOx).

A semiconductor layer 140 is formed between the gate electrode 121 and the source/drain electrodes 151 and 153. The semiconductor layer 140 may include an active layer 141 and an ohmic contact layer 143. For example, the active layer 141 may comprise amorphous silicon, and the ohmic contact layer 143 may comprise amorphous silicon doped with n+ ions. Herein, a portion of the semiconductor layer 140 formed on the gate electrode 121 is generally referred to as a channel layer 140 for forming a channel of the TFT.

A passivation layer 160 may be formed on the source/drain electrodes 151 and 153 of the TFT.

In one example embodiment, the pixel regions include a first red pixel region R1, a second red pixel region R2, a third red pixel region R3, a first green pixel region G1, a second green pixel region G2, a third green pixel region G3, a first blue pixel region B1, a second blue pixel region B2 and a third blue pixel region B3.

In the embodiment illustrated in FIG. 1, the red, green and blue pixel regions are successively arranged in the first direction. For example, the first green pixel region G1 is arranged next to the first red pixel region R1, and the first blue pixel region B1 is arranged next to the first green pixel region G1 along the first direction. However, the sequence order of the arrangement of the color pixel regions is not limited to the above-described order. In another example embodiment, the color pixel regions may be alternately arranged in both first and second directions. For example, the first red pixel region R1, the first green pixel region G1 and the first blue pixel region B1 may be successively arranged in the first direction, and the first red pixel region R1, the second green pixel region G2 and the third blue pixel region B3 may be successively arranged in the second direction.

The first substrate 100 further includes a color filter layer 170 that covers the TFT including the gate electrode 121, the source electrode 151 and the drain electrode 153. In the embodiment of FIG. 3, only a blue color filter layer 170 formed in the second blue pixel region B2 is illustrated since FIG. 3 shows a cross-section of the second blue pixel region B2.

Although not illustrated in FIGS. 1 to 3, it will be understood that not only the blue color filter layer 170, but also a red color filter layer (not illustrated) and a green color filter layer (not illustrated) are formed at the red pixel regions R1, R2 and R3 and at the green pixel regions G1, G2 and G3, respectively. Just like the blue color filter layer 170 is formed to cover the TFT at the blue pixel regions B1, B2 and B3, the red color filter layer and the green color filter layer may also be formed to cover the TFT at the red pixel regions R1, R2 and R3 and at the green pixel regions G1, G2 and G3, respectively.

In an example embodiment, a capping layer (not illustrated) may be formed on the color filter layer 170. The capping layer prevents ion impurities generated in the color filter layer 170 from penetrating into the liquid crystal layer 300.

A pixel electrode 180 may be formed on the color filter layer 170. Examples of a transparent conductive material that may be used for the pixel electrode 180 include indium tin oxide (ITO), indium zinc oxide (IZO), zinc oxide (ZO), etc. The pixel electrode 180 is electrically connected to the drain electrode 153 of the TFT through a contact hole 190 that is perforated through the color filter layer 170.

The second substrate 200 includes a common electrode 220 formed on a second base substrate 210. Examples of a transparent conductive material that may be used for the common electrode 220 include indium tin oxide (ITO), indium zinc oxide (IZO), zinc oxide (ZO), etc.

The liquid crystal layer 300 includes a plurality of liquid crystal molecules interposed between the first substrate 100 and the second substrate 200. An electric field generated between the pixel electrode 180 and the common electrode 220 changes an arrangement of the liquid crystal molecules to display an image.

The second substrate 200 further includes a first spacer 260 and a second spacer 270 that are formed on the second base substrate 210. When the first substrate 100 and the second substrate 200 are combined or coupled, the first spacer 260 and the second spacer 270 regularly maintain a distance between the first and second substrates 100 and 200.

In the example embodiment described with reference to FIGS. 1 to 3, the first and second spacers 260 and 270 are fixed at the second substrate 200 so that the first and second spacers 260 and 270 are disposed at a desired position. However, embodiments of the present invention are not limited to the above-described structure, and the first spacer 260 or the second spacer 270 may not be fixed at the second substrate 200.

A length or a shape of the first and second spacers 260 and 270 is not limited. However, in order to simplify a process, the first spacer 260 and the second spacer 270 may have substantially the same length. Further, the first spacer 260 and the second spacer 270 may have substantially the same shape. For example, the first spacer 260 and the second spacer 270 may have a shape of a column or a cylinder.

When the first substrate 100 and the second substrate 200 are combined or coupled, the first spacer 260 makes contact with the first substrate 100. In an example embodiment, the first spacer 260 is correspondingly disposed at a position where the TFT is formed, and makes contact with the first substrate 100. However, the location of the first spacer 260 is not limited to the position where the TFT is formed. That is, the first spacer 260 may be disposed anywhere except in an area where optical efficiency is reduced. For example, the first spacer 260 may be disposed on the data line GLm, or it may be disposed on the storage line (not illustrated).

As described above, when the number of spacers is too small, a stress applied to each spacer is so large that the spacer may be easily transformed or broken down. Conversely, when the number of spacers is too large, the liquid crystal molecules may not be regularly distributed. In order to solve the above-mentioned problems, the liquid crystal display panel 500 in accordance with an embodiment of the present invention employs the second spacer 270 for dispersing a stress. Further, to distribute the liquid crystal molecules, the second spacer 270 may be spatially separated from the first substrate 100 by a predetermined distance when the first substrate 100 and the second substrate 200 are combined or coupled.

In an example embodiment of the present invention, the color filter layer 170 may have a recess portion 175 recessed by a predetermined depth. The second spacer 270 is disposed at a portion corresponding to the recess portion 175 of the color filter layer 170. Accordingly, when the first substrate 100 and the second substrate 200 are combined or coupled, the second spacer 270 is disposed over the recess portion 175, so that the second spacer 270 is separated from the first substrate 100 by the recessed depth of the recess portion 175.

The separation distance between the second spacer 270 and the first substrate 100, i.e., the recessed depth of the recess portion 175, may be adjusted in a process of forming the recess portion 175 as needed. For example, the recessed depth of the recess portion 175 may be relatively shallow. Alternatively, the color filter layer 170 may be perforated to form the recess portion 175.

Although a shape of a cross section of the recess portion 175 taken in parallel with an upper surface of the first base substrate 110 is a square, the shape of the cross section of the recess portion 175 is not limited to a square. For example, the cross section of the recess portion 175 may have various shapes such as a pentagon, a hexagon, a circle, an ellipse, etc. Alternatively, the cross section of the recess portion 175 may be substantially the same as a cross section of the second spacer 270.

In the example embodiment described with reference to FIGS. 1 to 3, the recess portion 175 is formed over the gate line GLn, and the second spacer 270 is disposed over the gate line GLn. However, the position of the second spacer 270 is not limited to the above-described position. For example, the second spacer 270 may be disposed over the data line DLm, or it may be disposed over the storage line (not illustrated). Accordingly, a recess portion similar to the recess portion 175 may be formed over the data line DLm or the storage line corresponding to the position where the second spacer 270 is disposed.

In the example embodiment described with reference to FIGS. 1 to 3, the first spacer 260 and the second spacer 270 are disposed adjacent to each other in the same pixel region such as the first blue pixel region B1, the second blue pixel region B2, etc. Alternatively, the first spacer 260 and the second spacer 270 may be disposed apart in different pixel regions. For example, the second spacer 270 may be disposed in the second green pixel region G2, while the first spacer 260 may be disposed in the second blue pixel region B2. In another example embodiment, the first spacer 260 and the second spacer 270 are disposed in all pixel regions. As mentioned above, when the number of spacers is too large, the liquid crystal molecules may not be regularly distributed. Thus, the number and the position of the spacers 260 and 270 may be properly adjusted according to the field of applications.

When the recess portion 175 is formed at the color filter layer 170 to separate the second spacer 270 from the first substrate 100 by a predetermined distance, the thickness of the color filter layer 170 becomes thinner at the region where the recess portion 175 is formed. Thus, although not inevitable, light may leak through the region where the recess portion 175 is formed. The leakage of light may deteriorate the quality of the liquid crystal display panel. According to an example embodiment of the present invention, a protrusion pattern 125 is formed under the recess portion 175 of the color filter layer 170 to prevent the leakage of light.

As described in FIGS. 1 to 3, when the recess portion 175 and the second spacer 270 are disposed over the gate line GLn, the protrusion pattern 125 protrudes in the second direction from the gate line GLn at a position corresponding to the position of the recess portion 175. In an example embodiment, the protrusion pattern 125 may be formed together in a process for forming the gate pattern 120, which includes the gate lines GLn-1 and GLn and the gate electrode 121. That is, the gate pattern 120 may further include the protrusion pattern 125 comprising the same material as the gate lines GLn-1 and GLn and the gate electrode 121.

In another example embodiment (not illustrated), when the recess portion 175 and the second spacer 270 are disposed over the data line DLm, an alternative protrusion pattern may protrude in the first direction from the data line DLm at a position corresponding to the position of the recess portion 175.

A perimetric size of the protrusion pattern 125 may be properly adjusted according to a size of the recess portion 175 or an amount of the light leakage. In order to effectively prevent the leakage of light, according to an embodiment, the perimetric size of the protrusion pattern 125 may be the same as or larger than that of the recess portion 175.

Although a shape of a cross section of the protrusion pattern 125 taken in parallel with an upper surface of the first base substrate 110 is a square according to the embodiment of FIGS. 1 and 2, the shape of the cross section of the protrusion pattern 125 is not limited to a square. For example, the cross section of the protrusion pattern 125 may have various shapes such as a pentagon, a hexagon, a circle, an ellipse, etc. Alternatively, the cross section of the protrusion pattern 125 may be substantially the same as the cross section of the recess portion 175 and/or the second spacer 270. The protrusion pattern 125 may block light passing through the liquid crystal display panel and thus may reduce optical efficiency. Therefore, the size of the protrusion pattern 125 may be no larger than the size capable of preventing light from being leaked through the recess portion 175. The size or shape of the protrusion pattern 125 may be properly optimized to prevent the leakage of light and minimize the reduction of optical efficiency.

As described above, the number of spacers 260 and 270 disposed in the liquid crystal display panel 500 may be properly adjusted as needed. When the second spacer 270 needs to be formed in every pixel region, the recess portion 175 may be also formed in every pixel region. Accordingly, the protrusion pattern 125 may be also formed in every pixel region.

When a required number of the second spacer 270 is smaller than the number of all the pixel regions, the second spacer 270 and the corresponding protrusion pattern 125 may be disposed at a position capable of minimizing the reduction of optical efficiency. For example, when the required number of the second spacer 270 is one third of the number of the entire pixel regions, the second spacer 270 and the protrusion pattern 125 may be disposed only in every blue pixel region, because transmittance of the blue pixel region is the lowest. Since the transmittance of the blue pixel region is lower than that of the red pixel region and the green pixel region, the reduction rate of optical efficiency caused by the protrusion pattern 125 may be lowest in the blue pixel region. However, embodiments of the present invention are not limited to this. That is, the second spacer 270 and the protrusion pattern 125 may be formed not only in the blue pixel regions B1, B2 and B3, but also in the red pixel regions R1, R2 and R3 or in the green pixel regions G1, G2 and G3, as needed.

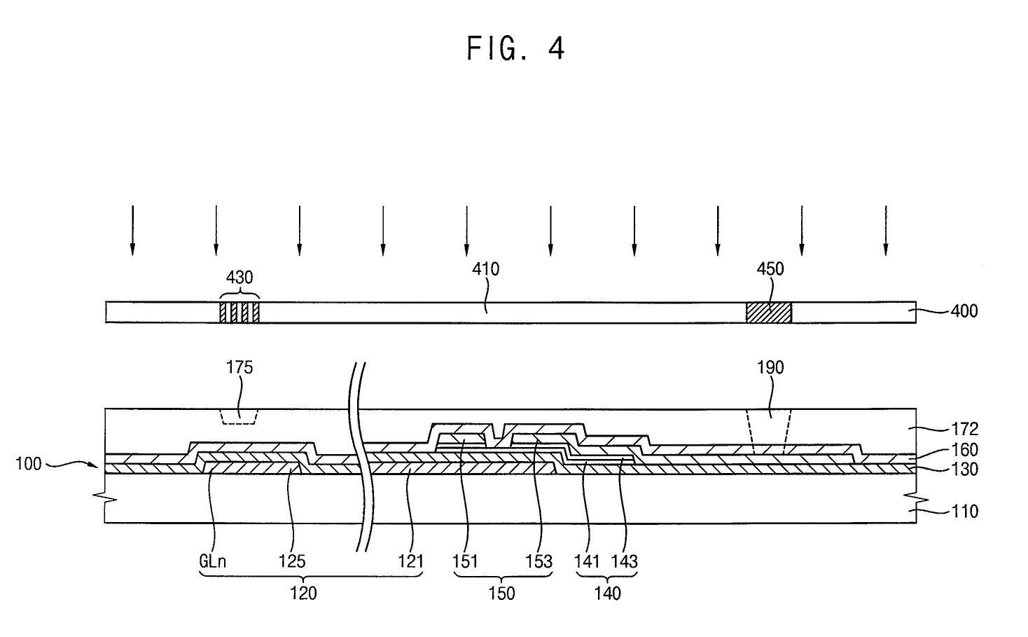

FIG. 4 is a cross-sectional view illustrating a method of manufacturing a liquid crystal display panel illustrated in FIGS. 1 to 3 according to an embodiment.

Referring to FIGS. 1, 2, 3 and 4, a gate pattern 120 is formed on a first base substrate 110 of a first substrate 100. The gate pattern 120 includes a plurality of gate lines GLn-1 and GLn and a gate electrode 121 extending from the gate lines GLn-1 and GLn. In an example embodiment, the gate pattern 120 may further include a protrusion pattern 125 protruding from the gate lines GLn-1 and GLn, corresponding to a region where a recess portion 175 is to be formed. Further, a data pattern 150 is formed on the base substrate 110. The data pattern 150 includes a plurality of data lines DLm-3, DLm-2, DLm-1 and DLm, a source electrode 151 extending from the data lines DLm-3, DLm-2, DLm-1 and DLm, and a drain electrode 153 separated from the source electrode 151. The gate electrode 121, the source electrode 151 and the drain electrode 153 constitute a TFT that is a kind of switching element.

A gate insulation layer 130 covering the gate pattern 120 may be further formed on the first substrate 100. A semiconductor layer 140 may be formed between the gate electrode 121 and the source/drain electrodes 151 and 153. A passivation layer 160 may be formed on the source electrode 151 and the drain electrode 153 of the TFT.

A photoresist 172 is deposited on the first substrate 100 to cover the TFT. The photoresist 172 may include a dye or a pigment. For example, a red dye or a red pigment may be used to form a red color filter layer, and a green dye or a green pigment may be used to form a green color filter layer. Likewise, a blue dye or a blue pigment may be used to form a blue color filter layer.

In an example embodiment, the photoresist 172 includes a photosensitive material. For example, the photoresist 172 may include a negative type photoresist, and thus an exposed portion of the photoresist 172 remains and a shaded portion of the photoresist 172 may be removed by a developing agent.

A mask 400 is disposed over the first substrate 100 on which the photoresist 172 is deposited. The mask 400 may include a transparent portion 410 for forming a color filter layer, a slit pattern 430 corresponding to a position where a recess portion 175 (illustrated by a perforated line) is to be formed, and a shading portion 450 corresponding to a position where a contact hole 190 (illustrated by a perforated line) is to be formed.

The photoresist 172 is exposed to light irradiated from an exterior over the mask 400. The transparent portion 410 transmits the light, and the shading portion 450 blocks the light. The slit pattern 430 partially transmits the light. The size of the slit pattern 430 or an interval between silts may be adjusted to control the amount of the transmitted light.

Since the photoresist 172 is a negative type, a color filter layer is formed at a portion exposed to the light, and a shaded portion is removed by a developing agent. Accordingly, the contact hole 190 is formed at the portion corresponding to the shading portion 450 of the mask 400, and the recess portion 175 is formed at the portion corresponding to the slit pattern 430. The extent of the light passing through the slit pattern 430 may be controlled to adjust a recessed depth of the recess portion 175. The recessed depth of the recess portion 175 may be determined in the process of forming the recess portion 175 as needed.

In an example embodiment, an interval between slits may be narrow in a center portion of the slit pattern 430 and broad in a peripheral portion thereof. Accordingly, relatively less light may pass through the center portion of the slit pattern 430, and relatively more light may pass through the peripheral portion of the slit pattern 430. Therefore, the photoresist 172 corresponding to the center portion of the slit pattern 430 is relatively more removed, and the photoresist 172 corresponding to the peripheral portion of the slit pattern 430 is relatively less removed. That is, the recess portion 175 may have an inclined wall.

In another example embodiment, a shading layer may substitute for the slit pattern 430 to form a recess portion perforating the color filter layer. Alternatively, a halftone mask having a translucent layer may substitute for the mask 400 having the slit pattern 430.

Referring back to FIGS. 1, 2 and 3, the method of manufacturing the liquid crystal display panel 500 in accordance with an embodiment of the present invention further includes forming a second substrate 200 that includes a first spacer 260 and a second spacer 270. The first spacer 260 is formed on a second base substrate 210 to make contact with the first substrate 100. The second spacer 270 is disposed at a position corresponding to the recess portion 175.

In an example embodiment, an organic photosensitive material (not illustrated) may be deposited on the second base substrate 210, and the organic photosensitive material may be patterned to form the first spacer 260 and the second spacer 270.

Liquid crystal molecules are disposed on the first substrate 100. For example, the disposition of the liquid crystal molecules may be performed by an apparatus for dropping a liquid crystal molecule.

The first substrate 100 and the second substrate 200 are combined or coupled so that the first spacer 260 makes contact with the first substrate 100 and the second spacer 270 is disposed over the recess portion 175.

When the first substrate 100 and the second substrate 200 are combined or coupled, the second spacer 270 is disposed over the recess portion 175, and thus the second spacer 270 is separated from the first substrate 100 by a recessed depth of the recess portion 175. As described above, the recessed depth of the recess portion 175 may be adjusted by controlling the amount of light incident on the photoresist 172.

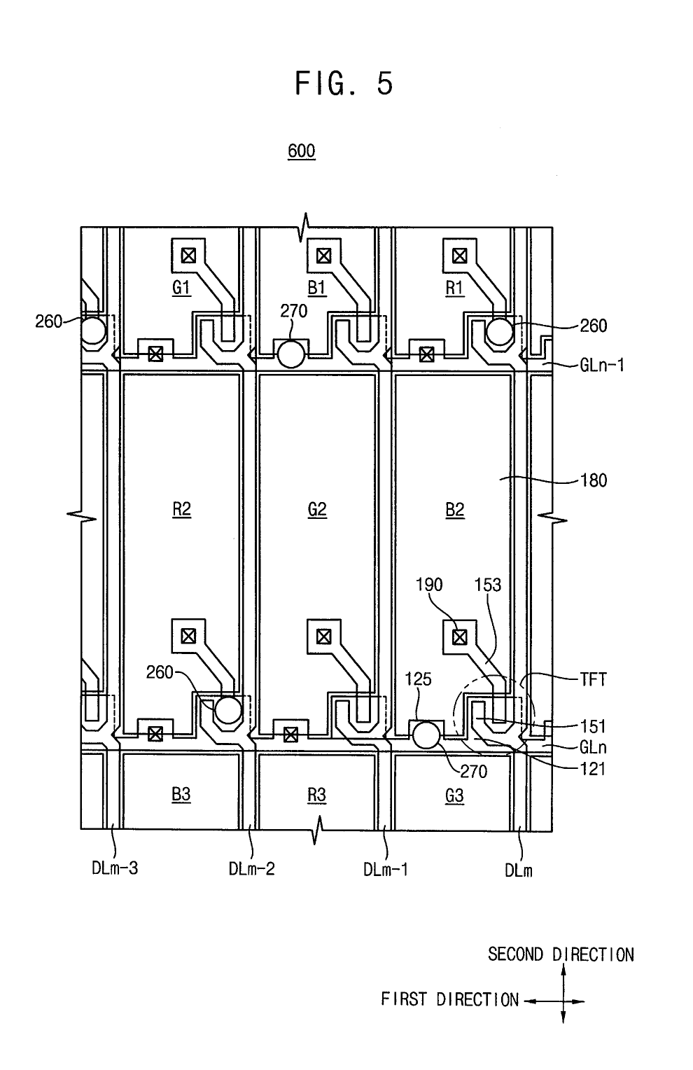

FIG. 5 is a plan view illustrating a liquid crystal display panel in accordance with another example embodiment of the present invention.

The liquid crystal display panel 600 described with reference to the embodiment of FIG. 5 may have substantially the same structure as the liquid crystal display panel 500 described with reference to the embodiment of FIGS. 1 to 3, except for the sequence order of the arrangement of the red, green and blue color pixel regions, dispositions of spacers and the position of a protrusion pattern. Therefore, the same reference numbers are used for the same or similar elements, and any further descriptions concerning the same or similar elements as those described in FIGS. 1 to 3 will be omitted.

Referring to FIGS. 3 and 5, a liquid crystal display panel 600 includes a first substrate 100, a second substrate 200 and a liquid crystal layer 300 interposed between the first and second substrates 100 and 200.

A gate pattern 120 is formed on the first substrate 100. The gate pattern 120 includes a plurality of gate lines GLn-1 and GLn extending in a first direction, and a gate electrode 121 extending from the gate lines GLn-1 and GLn. Herein, ‘n’ represents a natural number larger than one. Further, a data pattern 150 is formed on the first substrate 100. The data pattern 150 includes a plurality of data lines DLm-3, DLm-2, DLm-1 and DLm extending in a second direction substantially perpendicular to the first direction, a source electrode 151 extending from the data lines DLm-3, DLm-2, DLm-1 and DLm, and a drain electrode 153 separated from the source electrode 151. Herein, ‘m’ represents a natural number larger than three. The gate electrode 121, the source electrode 151 and the drain electrode 153 constitute a TFT that is a kind of switching element.

The liquid crystal display panel 600 is divided into a plurality of pixel regions. In the example embodiment illustrated in FIG. 5, the TFT may be formed in each pixel region. The pixel regions include a first red pixel region R1, a second red pixel region R2, a third red pixel region R3, a first green pixel region G1, a second green pixel region G2, a third green pixel region G3, a first blue pixel region B1, a second blue pixel region B2 and a third blue pixel region B3.

In the embodiment illustrated in FIG. 5, the red, green and blue pixel regions are alternately arranged in both the first direction and the second direction. That is, color pixel regions having the same color are not arranged adjacent to each other. For example, when the second red pixel region R2, the second green pixel region G2 and the second blue pixel region B2 are sequentially arranged in the first direction, the first red pixel region R1 is arranged above the second blue pixel region B2, and the third green pixel region G3 is arranged below the second blue pixel region B2. That is, the first red pixel region R1, the second blue pixel region B2 and the third green pixel region G3 are sequentially arranged in the second direction in the liquid crystal display panel 600 described with reference to the embodiment of FIG. 5 unlike the liquid crystal display panel 500 described with reference to the embodiment of FIG. 1.

The first substrate 100 further includes a color filter layer 170 that covers the TFT including the gate electrode 121, the source electrode 151 and the drain electrode 153. The color filter layer 170 has been already described with reference to FIGS. 1 to 3, and thus further descriptions will be omitted.

The liquid crystal display panel 600 further includes a first spacer 260 and a second spacer 270. The first spacer 260 and the second spacer 270 maintain a distance between the first and second substrates 100 and 200, regularly. When the first substrate 100 and the second substrate 200 are combined or coupled, the first spacer 260 makes contact with the first substrate 100.

In an example embodiment described with reference to FIG. 5, the first spacer 260 is disposed correspondingly at positions where the TFT is formed in the first, second and third red color pixel regions R1, R2 and R3, and makes contact with the first substrate 100.

The second spacer 270 is disposed over the gate lines GLn-1 and GLn formed in the first, second and third blue color pixel regions B1, B2 and B3. That is, the first spacer 260 and the second spacer 270 are disposed in different color pixel regions, respectively. Accordingly, a distance between the first spacer 260 and the second spacer 270 is relatively long, and the arrangement of the spacers 260 and 270 may be dispersed. When the arrangement of the spacers 260 and 270 is dispersed, a stress applied from an exterior may be regularly dispersed.

Similar to the example embodiment described with respect to FIGS. 1 to 3, the color filter layer 170 of the liquid crystal display panel 600 may have a recess portion 175 recessed by a predetermined depth, and the second spacer 270 may be disposed at a portion corresponding to the recess portion 175 of the color filter layer 170. Accordingly, when the first substrate 100 and the second substrate 200 are combined or coupled, the second spacer 270 is disposed over the recess portion 175, so that the second spacer 270 is separated from the first substrate 100 by the recessed depth of the recess portion 175.

When the recess portion 175 is formed at the color filter layer 170 to separate the second spacer 270 from the first substrate 100 by a predetermined distance, although not inevitable, light may leak through the region where the recess portion 175 is formed. The leakage of light may deteriorate the quality of the liquid crystal display panel. According to an example embodiment of the present invention, a protrusion pattern 125 is formed to prevent the leakage of light.

When the second spacer 270 is disposed over the gate lines GLn-1 and GLn, a protrusion pattern 125 protruding in the second direction from the gate lines GLn-1 and GLn at a position corresponding to the position of the recess portion 175 is formed. In this example embodiment, the protrusion pattern 125 may be formed together in a process for forming the gate pattern 120, which includes the gate lines GLn-1 and GLn and the gate electrode 121.

In the example embodiment described with reference to FIG. 5, the recess portion 175 and the protrusion pattern 125 are formed in every pixel region, while the second spacers 270 are disposed only in the first, second and third blue pixel regions. When the color filter layer 170 is patterned by using one common mask, the patterns of the color filter layer 170 are all the same in every pixel region as illustrated in FIG. 5. Therefore, the recess portion 175 and the protrusion pattern 125 are formed in every pixel region. Alternatively, when two masks different from each other are used instead of the common mask, the recess portion 175 and the protrusion pattern 125 may be formed only in the blue pixel regions B1, B2 and B3 as illustrated in FIG. 1.

A method of manufacturing the liquid crystal display panel 600 described with reference to the embodiment of FIG. 5 may be substantially the same as the method of manufacturing the liquid crystal display panel 500 described with reference to the embodiment of FIGS. 1 to 4, except for the sequence order of the arrangement of the red, green and blue color pixel regions, dispositions of spacers and the disposition of a protrusion pattern. Therefore, any further descriptions will be omitted.

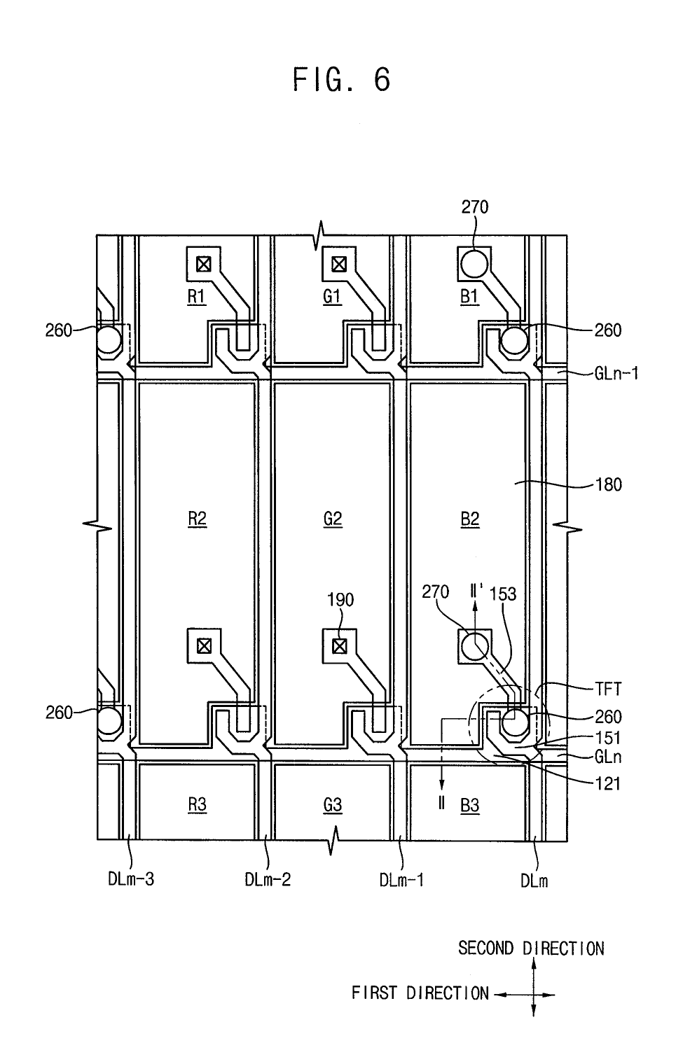

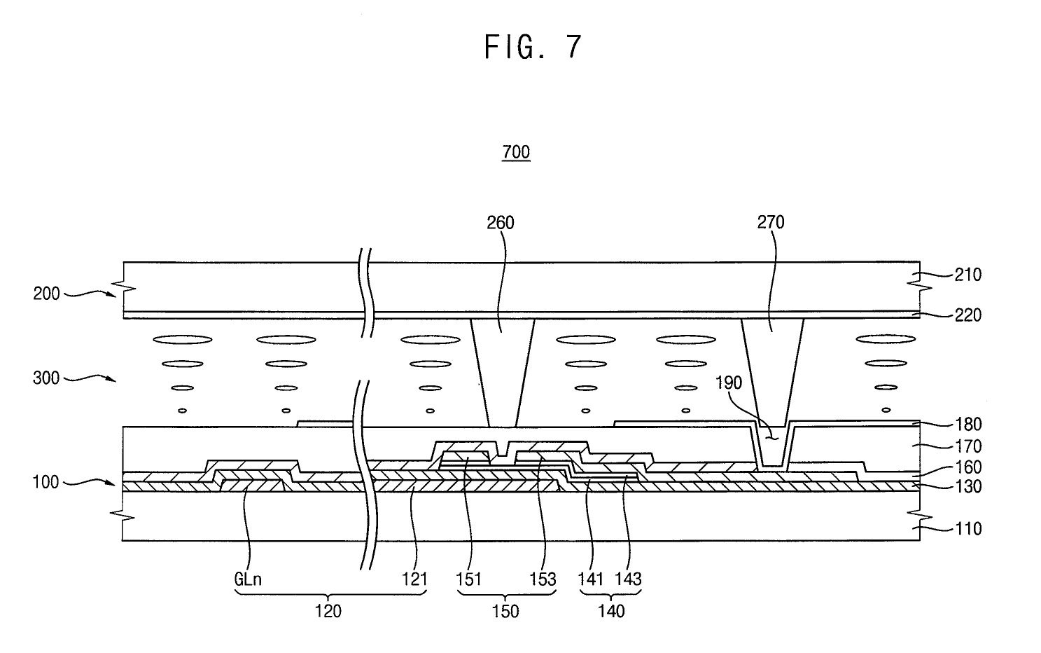

FIG. 6 is a plan view illustrating a liquid crystal display panel in accordance with another example embodiment of the present invention. FIG. 7 is a cross-sectional view of the liquid crystal display panel taken along lines II-II′ in FIG. 6.

The liquid crystal display panel 700 described with reference to the embodiment of FIGS. 6, and 7 may have substantially the same structure as the liquid crystal display panel 500 described with reference to the embodiment of FIGS. 1 to 3, except for dispositions of spacers and an absence of a protrusion pattern and a recess portion. Therefore, the same reference numbers are used for the same or similar elements, and any further descriptions concerning the same or similar elements as those described in FIGS. 1 to 3 will be omitted.

Referring to FIGS. 6 and 7, a liquid crystal display panel 700 includes a first substrate 100, a second substrate 200 and a liquid crystal layer 300 interposed between the first and second substrates 100 and 200.

A gate pattern 120 is formed on the first substrate 100. The gate pattern 120 includes a plurality of gate lines GLn-1 and GLn extending in a first direction, and a gate electrode 121 extending from the gate lines GLn-1 and GLn. Herein, ‘n’ represents a natural number larger than one. Further, a data pattern 150 is formed on the first substrate 100. The data pattern 150 includes a plurality of data lines DLm-3, DLm-2, DLm-1 and DLm extending in a second direction substantially perpendicular to the first direction, a source electrode 151 extending from the data lines DLm-3, DLm-2, DLm-1 and DLm, and a drain electrode 153 separated from the source electrode 151. Herein, ‘m’ represents a natural number larger than three. The gate electrode 121, the source electrode 151 and the drain electrode 153 constitute a TFT that is a kind of switching element.

The first substrate 100 is divided into a plurality of pixel regions. The TFT may be formed in each pixel region of the first substrate 100. The first substrate 100 may further include a gate insulation layer 130 formed on a first base substrate 110 to cover the gate pattern 120. A channel layer 140 may be formed between the gate electrode 121 and the source/drain electrodes 151 and 153. A passivation layer 160 may be formed on the source electrode 151 and the drain electrode 153 of the TFT.

In the embodiment illustrated in FIG. 6, the green pixel regions G1, G2 and G3 are arranged next to the red pixel regions R1, R2 and R3, respectively, and the blue pixel regions B1, B2 and B3 are arranged next to the green pixel regions G1, G2 and G3, respectively.

The first substrate 100 further includes a color filter layer 170 that covers the TFT including the gate electrode 121, the source electrode 151 and the drain electrode 153. In the embodiment of FIG. 7, only a blue color filter layer 170 formed in the second blue pixel region B2 is illustrated since FIG. 7 shows a cross section of the second blue pixel region B2.

A pixel electrode 180 may be formed on the color filter layer 170. The pixel electrode 180 is electrically connected to the drain electrode 153 of the TFT through a contact hole 190 perforated through the color filter layer 170.

The second substrate 200 includes a first spacer 260 and a second spacer 270, both of which are formed on a second base substrate 210.

In the example embodiment described with reference to FIGS. 6 and 7, when the first substrate 100 and the second substrate 200 are combined or coupled, the first spacer 260 is correspondingly disposed at a position where the TFT is formed and makes contact with the first substrate 100. However, the location of the first spacer 260 is not limited to the position to where the TFT is formed.

As described above, in order to regularly distribute liquid crystal molecules, the second spacer 270 is spatially separated from the first substrate 100 by a predetermined distance when the first substrate 100 and the second substrate 200 are combined or coupled.

In an example embodiment, the second spacer 270 is correspondingly disposed at a position where the contact hole 190 is formed. That is, when the first substrate 100 and the second substrate 200 are combined or coupled, the second spacer 270 is disposed over the contact hole 190 so that it is separated from the first substrate 100 by the recessed depth of the contact hole 190. In the example embodiment described with reference to FIG. 7, unlike the embodiment of FIG. 3, an additional recessed portion is not formed at the color filter layer 170, and the contact hole 190 substitutes for the recessed portion. That is, the contact hole 190 may function similarly to the recessed portion 175 of FIG. 3. However, the position of the second spacer 270 is limited to the upper position of the contact hole 190, and the recessed depth may be not adjusted as needed.

In the example embodiment described with reference to FIGS. 6 and 7, the first spacer 260 and the second spacer 270 are disposed in the same pixel region, i.e., the first and second blue pixel regions B1 and B2, and are disposed adjacent to each other. Alternatively, the first spacer 260 and the second spacer 270 may be disposed in the different pixel regions. For example, when first spacer 260 is disposed in the second blue pixel region B2, the second spacer 270 may be disposed over a contact hole 190 in the second green pixel region G2. In another example embodiment, the first spacer 260 and the second spacer 270 may be disposed in every pixel region. As mentioned above, when the number of spacers is too large, the liquid crystal molecules may not be regularly distributed. Thus, the number and the position of the spacers 260 and 270 may be properly adjusted according to the field of applications.

A method of manufacturing the liquid crystal display panel 700 described with reference to the embodiment of FIGS. 6 and 7 may be substantially the same as the method of manufacturing the liquid crystal display panel 500 described with reference to the embodiment of FIGS. 1 to 4, except that the second spacer 270 is disposed over the contact hole 190 and a protrusion pattern and a recess portion are not formed. Therefore, any further descriptions will be omitted.

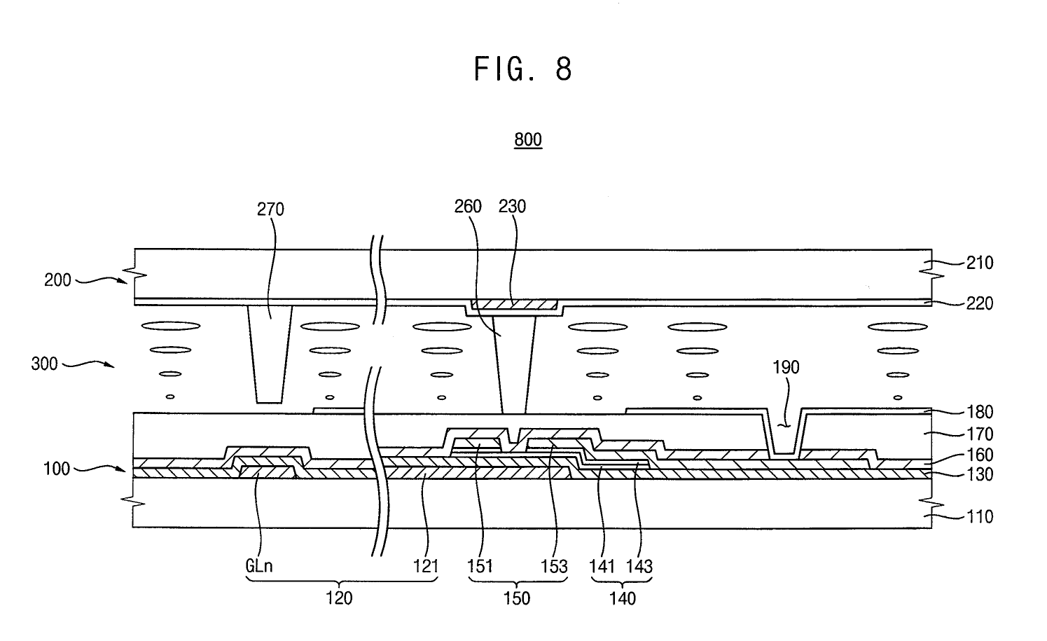

FIG. 8 is a cross-sectional view of a liquid crystal display panel in accordance with another example embodiment of the present invention.

The liquid crystal display panel 800 described with reference to the embodiment of FIG. 8 may have substantially the same structure as the liquid crystal display panel 500 described with reference to the embodiment of FIGS. 1 to 3, except that a protrusion pattern and a recess portion are not formed and a first spacer is disposed on a region where a shading layer is formed. Therefore, the same reference numbers are used for the same or similar elements, and any further descriptions concerning the same or similar elements as those described in FIGS. 1 to 3 will be omitted.

Referring to FIG. 8, a liquid crystal display panel 800 includes a first substrate 100, a second substrate 200 and a liquid crystal layer 300 interposed between the first and second substrates 100 and 200.

A gate pattern 120 and a data pattern 150 are formed on a first base substrate 110 of the first substrate 100. The gate pattern 120 includes a gate line GLn and a gate electrode 121. The data pattern 150 includes a source electrode 151 and a drain electrode 153. Th e gate electrode 121, the source electrode 151 and the drain electrode 153 constitute a TFT that is a kind of switching element.

The first substrate 100 may further include a gate insulation layer 130 formed on a first base substrate 110 to cover the gate pattern 120. A channel layer 140 may be formed between the gate electrode 121 and the source/drain electrodes 151 and 153. A passivation layer 160 may be formed on the source electrode 151 and the drain electrode 153 of the TFT.

The first substrate 100 further includes a color filter layer 170 that covers the TFT including the gate electrode 121, the source electrode 151 and the drain electrode 153. A pixel electrode 180 may be formed on the color filter layer 170. The pixel electrode 180 is electrically connected to the drain electrode 153 of the TFT through a contact hole 190 perforated through the color filter layer 170.

The second substrate 200 includes a common electrode 220 formed on a second base substrate 210, a shading layer 230 formed on a portion of the base substrate 210, a first spacer 260 and a second spacer 270.

In the example embodiment described with reference to FIG. 8, the first spacer 260 is disposed on the region where the shading layer 230 is formed. Further, the first spacer 260 makes contact with the first substrate 100 when the first substrate 100 and the second substrate 200 are combined or coupled. The second spacer 270 is disposed at a region where the shading layer 230 is not formed, and is spatially separated from the first substrate 100 by a predetermined distance when the first and second substrates 100 and 200 are combined or coupled.

The second spacer 270 is disposed anywhere except in an area where the shading layer 230 is formed. For example, when the shading layer 230 is not formed at a portion of the second substrate 200 facing the gate line GLn, the second spacer 270 may be disposed over the gate line GLn when the first and second substrates 100 and 200 are combined or coupled. When the shading layer 230 is not formed at a portion of the second substrate 200 facing a data line (not illustrated), the second spacer 270 may be disposed over the data line when the first and second substrates 100 and 200 are combined or coupled.

In an example embodiment, the first spacer 260 and the second spacer 270 may have substantially the same length. Further, the first spacer 260 and the second spacer 270 may have substantially the same shape. For example, the first spacer 260 and the second spacer 270 may have a shape of a column or a cylinder. When the first spacer 260 and the second spacer 270 have substantially the same length, a separation distance between the first spacer 260 and the second spacer 270 may be substantially the same as the thickness of the shading layer 230.

Referring back to FIG. 8, a method of manufacturing the liquid crystal display panel 800 will be described according to an embodiment. A TFT is formed on the first substrate 100, and a color filter layer 70 is formed to cover the TFT. The method of forming the first substrate 100 may be substantially the same as the method of forming the first substrate 100 described with reference to the embodiment of FIGS. 1, 3 and 4, except that a protrusion pattern (element 125 of FIG. 3) is not formed at the color filter layer 170. Therefore, any further descriptions will be omitted.

To form the shading layer 230 on the second substrate 200, a metal such as chromium or an organic material is coated on the second base substrate 210, and the metal or the organic material is patterned to form the shading layer 230. The shading layer 230 is formed on a portion of the second base substrate 210. A common electrode 220 is formed on the second base substrate 210 to cover the shading layer 230. Alternatively, the common electrode 220 may be previously formed on the second base substrate 210, and the shading layer 230 may be formed on the common electrode 220.

A first spacer 260 is formed on a region of the second base substrate 210 where the shading layer 230 is formed, and a second spacer 270 is formed on a region where the shading layer 230 is not formed. Accordingly, the second substrate 200 is completed.

Liquid crystal molecules are disposed on the first substrate 100. For example, the disposition of the liquid crystal molecules may be performed by an apparatus for dropping liquid crystal molecules. After the liquid crystal molecules are dropped on the first substrate 100, the first substrate 100 and the second substrate 200 are combined or coupled. When the first substrate 100 and the second substrate 200 are combined or coupled, the first spacer 260 makes contact with the first substrate 100 and the second spacer 270 is separated from the first substrate 100.

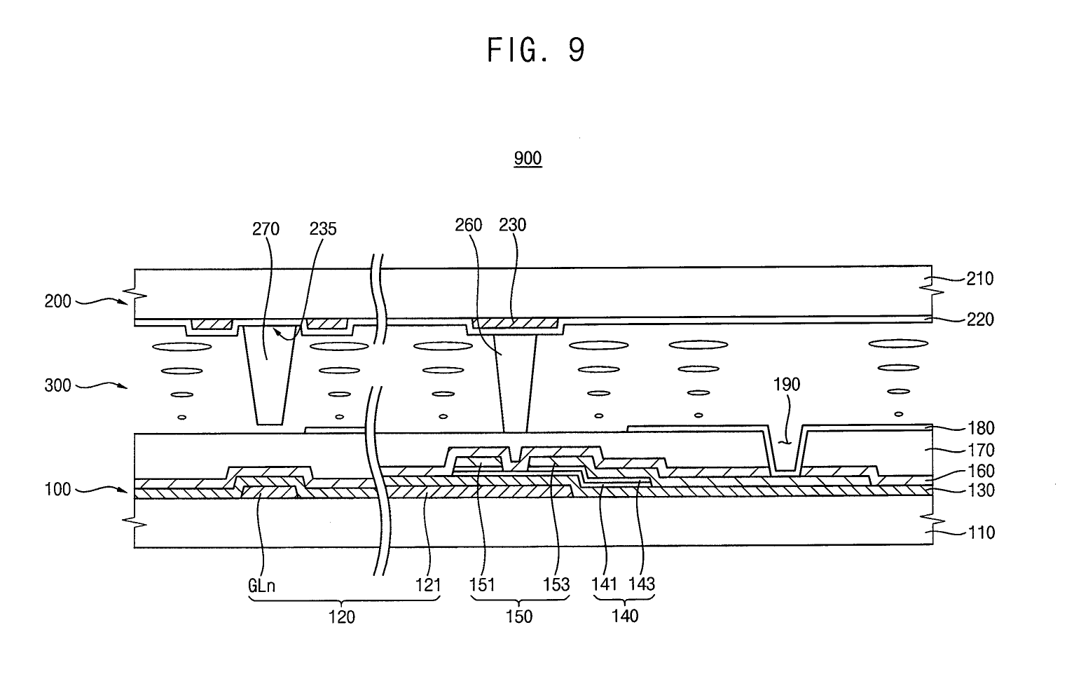

FIG. 9 is a cross-sectional view of a liquid crystal display panel in accordance with still another example embodiment of the present invention.

The liquid crystal display panel 900 described with reference to the embodiment of FIG. 9 may have substantially the same structure as the liquid crystal display panel 800 described with reference to the embodiment of FIG. 8, except that a second substrate 200 of the liquid crystal display panel 900 includes a shading layer 230 having a perforated hole 235 that exposes a portion of a second base substrate 210. Therefore, the same reference numbers are used for the same or similar elements described in FIG. 8, and any further descriptions concerning the same or similar elements as those will be omitted.

Referring to FIG. 9, the second substrate 200 of the liquid crystal display panel 900 includes a shading layer 230 having a perforated hole 235 that exposes a portion of a second base substrate 210.

For example, when it is necessary for the shading layer 230 to be formed around a region where the second spacer 270 is disposed, a portion of the shading layer 230 may be removed to form the perforated hole 235, in order to generate a step difference. The second spacer 270 is disposed in the perforated hole 235. In a process for patterning the shading layer 230, a mask having a pattern corresponding to the portion of the perforated hole 235 is used to form the shading layer 230 having the perforated hole 235.

A method of manufacturing the liquid crystal display panel 900 described with reference to the embodiment of FIG. 9 may be substantially the same as the method of manufacturing the liquid crystal display panel described with reference to the embodiments of FIGS. 1, 3, 4 and 8, except that the shading layer 230 is patterned to have the perforated hole 235 and the second spacer 270 is disposed in the perforated hole 235. Therefore, any further descriptions will be omitted.

According to some example embodiments of the present invention, a first spacer 260 making contact with a first substrate 100 and a second spacer 270 separated from the first substrate 100 are formed on a second substrate 200. Therefore, a stress applied from an exterior may be uniformly dispersed, and liquid crystal molecules may be regularly distributed.

The foregoing is illustrative of the present disclosure and is not to be construed as limiting thereof. Although a few example embodiments of the present invention have been described, those skilled in the art will readily appreciate that many modifications are possible in the example embodiments without materially departing from the novel teachings and advantages of the present disclosure. Accordingly, all such modifications are intended to be included within the scope of the present disclosure as defined in the claims. In the claims, means-plus-function clauses are intended to cover the structures described herein as performing the recited function and not only structural equivalents but also equivalent structures. Therefore, it is to be understood that the foregoing is illustrative of the present disclosure and is not to be construed as limited to the specific example embodiments disclosed, and that modifications to the disclosed example embodiments, as well as other example embodiments, are intended to be included within the scope of the appended claims. Embodiments of the present invention are defined by the following claims, with equivalents of the claims to be included therein.

What is claimed is:

1. A liquid crystal display panel comprising:
a first substrate including:
a first base substrate;
a thin-film transistor formed on the first base substrate; and
a color filter layer covering the thin-film transistor and having a recess portion;
a second substrate including:
a second base substrate;
a first spacer formed on the second base substrate, the first spacer making contact with the first substrate; and
a second spacer formed on the second base substrate, the second spacer being disposed at a position corresponding to the recess portion of the color filter layer to be separated from the first substrate; and
a liquid crystal layer interposed between the first substrate and the second substrate.

2. The liquid crystal display panel of claim 1, wherein the first spacer is correspondingly disposed at a position where the thin-film transistor is formed.

3. The liquid crystal display panel of claim 1, wherein the first spacer and the second spacer have substantially the same length.

4. The liquid crystal display panel of claim 1, wherein the first substrate further includes a protrusion pattern formed under the recess portion of the color filter layer, and the second spacer is correspondingly disposed at a position where the recess portion and the protrusion pattern are formed.

5. The liquid crystal display panel of claim 4, wherein the first substrate further includes a gate line extending in a first direction, and the protrusion pattern protrudes from the gate line.

6. The liquid crystal display panel of claim 4, wherein a perimetric size of the protrusion pattern is substantially the same as or lager than that of the recess portion.

7. The liquid crystal display panel of claim 4, wherein the first substrate is divided into a plurality of pixel regions, the pixel regions including:
a red pixel region where a red color filter layer is formed;
a green pixel region where a green color filter layer is formed; and
a blue pixel region where a blue color filter layer is formed.

8. The liquid crystal display panel of claim 7, wherein the protrusion pattern is formed only in the blue pixel region, and the second spacer is formed only in the blue pixel region.

9. The liquid crystal display panel of claim 7, wherein the protrusion pattern is formed in every pixel region, and the second spacer is formed only in the blue pixel region.

10. The liquid crystal display panel of claim 1, wherein the first substrate further includes a pixel electrode electrically connected to the thin-film transistor through a contact hole perforated through the color filter layer, and
wherein the recess portion corresponds to the contact hole, and the second spacer is disposed over the contact hole.

11. A liquid crystal display panel comprising:
a first substrate including:
a first base substrate;
a thin-film transistor formed on the first base substrate; and
a color filter layer covering the thin-film transistor and having a recess portion;
a second substrate including:
a second base substrate;
a shading layer formed at a portion of the second base substrate;
a first spacer formed on a region where the shading layer is formed, the first spacer making contact with the first substrate; and
a second spacer formed on a region where the shading layer is not formed, the second spacer being separated from the first substrate; and
a liquid crystal layer interposed between the first substrate and the second substrate.

12. The liquid crystal display panel of claim 11, wherein the shading layer is correspondingly formed at a position where the thin-film transistor is formed.

13. The liquid crystal display panel of claim 11, wherein the shading layer has a perforated hole exposing a portion of the second base substrate, and the second spacer is disposed in the perforated hole.

14. A method of manufacturing a liquid crystal display panel, the method comprising:
forming a first substrate including a color filter layer that covers a thin-film transistor formed on a first base substrate, the color filter layer having a recess portion;
forming a second substrate including a first spacer formed on a second base substrate to make contact with the first substrate and a second spacer disposed at a position corresponding to the recess portion of the color filter layer;
dropping liquid crystal molecules on the first substrate; and
combining the first substrate and the second substrate so that the first spacer makes contact with the first substrate and the second spacer is disposed over the recess portion.

15. The method of claim 14, wherein forming the first substrate includes:
forming a gate pattern on the first base substrate, the gate pattern including a gate line and a gate electrode extending from the gate line;
forming a data line, a source electrode and a drain electrode;
forming a photoresist covering the gate electrode, the source electrode and the drain electrode; and
patterning the photoresist to form the color filter layer having the recess portion.

16. The method of claim 15, wherein the gate pattern further includes a protrusion pattern protruding from the gate line, and the protrusion pattern is correspondingly formed at a region where the recess portion is formed.

17. The method of claim 15, wherein patterning the photoresist includes:
disposing a mask over the photoresist, the mask having a slit correspondingly disposed at a position where the recess portion is to be formed;
exposing the photoresist to an external light; and
developing the photoresist to form the color filter layer.

18. A method of manufacturing a liquid crystal display panel, the method comprising:
forming a first substrate including a color filter layer that covers a thin-film transistor formed on a first base substrate;
forming a second substrate including a shading layer formed on a portion of a second base substrate, a first spacer formed on the shading layer to make contact with the first substrate, and a second spacer disposed at a region where the shading layer is not formed;
dropping liquid crystal molecules on the first substrate; and
combining the first substrate and the second substrate so that the first spacer makes contact with the first substrate and the second spacer is spatially separated from the first substrate.

19. The method of claim 18, wherein forming the second substrate includes:
patterning the shading layer to have a perforated hole exposing a portion of the second base substrate; and
forming the second spacer in the perforated hole.
